(19) United States
(12) Patent Application Publication
(10) Pub. No.: US 2024/0375502 A1
(43) Pub. Date: Nov. 14, 2024

(54) VEHICLE SUB-ASSEMBLY

(71) Applicant: Robert Bosch GmbH, Stuttgart (DE)

(72) Inventors: Erik Goerres, Abstatt (DE); Heiko Kaiser, Schwieberdingen (DE)

(21) Appl. No.: 18/691,245

(22) PCT Filed: Aug. 11, 2022
(86) PCT No.: PCT/EP2022/072559

§ 371 Date: Mar. 12, 2024

(30) Foreign Application Priority Data
Oct. 1, 2021 (DE) 10 2021 211 057.6

(51) Int. Cl. B60K 1/04; B60K 1/00

(52) U.S. Cl. CPC B60K 1/04; B60K 2001/001; B60K 2001/0411

(57) ABSTRACT

The present invention relates to a vehicle sub-assembly (1) comprising a battery housing (2) with at least one fastening point (3); and at least one component of a drive train or of a wheel suspension (6), the component (4) being supported on the battery housing (2) via the at least one fastening point (3).

### BACKGROUND

The present invention relates to a vehicle sub-assembly with a battery housing and drive train or suspension components. Furthermore, the invention relates to a vehicle with the vehicle sub-assembly.

In today's vehicles with high-voltage electric drives, the battery is usually bolted against the underbody of the vehicle from below, and thereby usually occupies the largest possible space between the front axle and the rear axle. Since most battery electric vehicles (BEVs) are based on conventional vehicles with internal combustion engines, the body and axle designs are made accordingly and do not take into account the mechanical properties of the battery pack, but merely limit its space. Furthermore, the prior art knows concepts in which the battery pack is used as an integral part of the body or unibody. Although this eliminates the possibility of replacing the battery pack without further ado, it does achieve a significant streamlining of the vehicle body, as the battery becomes an integral part of the vehicle.

### SUMMARY

The vehicle sub-assembly according to the invention provides a battery housing on which further components can be supported, in particular fastened, directly or by means of a subframe. This makes it possible to provide a battery pack with a uniform battery housing to which different components can be attached, for example for different vehicle concepts or drive variants. For this purpose, the invention shows a vehicle sub-assembly comprising a battery housing and at least one component. This component is in particular part of a drive train or a wheel suspension. The battery housing has at least one fastening point. The component is supported on the battery housing via the at least one fastening point. This is done in particular by directly fastening the component to the fastening point or by fastening a subframe to the fastening point and in turn fastening the component to the subframe. Such a subframe can also be used to support the component on the battery housing. In particular, the battery housing is designed to be a supporting element of the unibody or the body of the vehicle. Thus, the battery housing is not only fastened to the vehicle, but integrated into the vehicle in such a way that it forms a load-bearing part of the vehicle and contributes to its stability.

The battery housing is preferably designed to accommodate several storage cells. In particular, the vehicle sub-assembly shown here comprises a battery arrangement, wherein the battery comprises the described battery housing with storage cells arranged therein. The battery arrangement is designed in particular to drive the vehicle.

The battery housing can have several of the fastening points. The individual component can be connected to the battery housing via several fastening points. Furthermore, it is also envisaged that several different components are supported on the battery housing.

The drive train components that can be supported on the battery housing are preferably a control arm, swing axle, stabilizer, strut, shock strut, spring or damper.

The components of the drive train that can be supported on the battery housing are in particular an electric motor, a gearbox or a drive shaft bearing.

Preferably one of these components, preferably several of them, is supported on the battery housing, i.e. either directly fastened to one of the fastening points or connected to the battery housing via the subframe.

In principle, various fastening points can be formed on the battery housing. Preferably, at least one fastening point is designed for screwing on one of the described components. For this purpose, it is preferably provided that the fastening point comprises at least one through hole, for example for the insertion of a bolt, and/or a stud bolt projecting from the battery housing. The corresponding component can be placed on such a stud bolt and screwed on, for example.

Additionally or alternatively, it is provided that at least one fastening point is formed as a welding surface on the battery housing. This welding surface is suitable in its size, design and choice of material for welding on one of the components described.

As described, the vehicle sub-assembly can have a subframe. The subframe is connected to the battery housing at at least one fastening point. In particular, the subframe is screwed and/or welded to the battery housing. At least one of the described components is fastened to the subframe and thereby supported on the battery housing by means of the subframe.

The subframe offers the advantage of flexibility and use of installation space for different suspensions, as well as considerable advantages in the area of pre-assembly during the production of the vehicles.

Between the subframe and the battery housing there is preferably at least one damping element, for example with an elastomer, in order to achieve additional damping between the chassis and the vehicle.

Preferably, at least one component of a left wheel suspension and at least one component of a right wheel suspension are fastened to the subframe. These components of the left or right wheel suspension are, for example, wishbones.

In a preferred embodiment, it is provided that the subframe comprises a left side area for fastening of the left wheel suspension and a right side area for fastening of the right wheel suspension. The two side areas are connected by a transverse area of the subframe. The transverse area is formed, for example, by one or more beams running transversely to the longitudinal direction of the vehicle.

The transverse area is preferably located below the battery housing and/or in front of the battery housing and/or behind the battery housing and/or above the battery housing. These orientations refer in particular to the use of the vehicle sub-assembly in the vehicle, so that, for example, in front of the battery housing means that the transverse area is located in front of the battery housing with respect to the longitudinal direction of the vehicle.

A recess is preferably formed in the battery housing. In particular, this recess is formed in the shape of an indentation. The recess serves to accommodate the subframe. In particular, at least the transverse area of the subframe runs in the recess. The battery housing can also comprise multiple recesses for multiple areas of the subframe. In particular, the recess is located on the lower side of the battery housing and the transverse area passes through this recess under the battery housing, thus connecting the left side section to the right side area of the subframe.

A recess in the battery housing, as can be used for the subframe, can also be used in a similar way when using transverse leaf springs, so that the transverse leaf springs can extend between the two wheel suspensions, for example under the battery housing.

The invention further comprises a vehicle with the vehicle sub-assembly described. The vehicle is preferably designed as a battery electric vehicle, wherein storage cells in the battery housing are used to drive the vehicle.

The invention shows a simplification and standardization of suspension concepts of a battery electric vehicle. In this case, the battery housing is integrated into the unibody of the vehicle as a supporting element and can thereby even extend the area of the front and/or rear of the vehicle. Such an integrated battery should be used in as many series and platforms as possible due to the development and safeguarding effort and in order to utilize economies of scale. However, this goal collides with the requirement for different suspension concepts, depending on the vehicle or drive concept. The fastening points on the battery housing according to the invention and in particular also the use of the subframe leads to a reduction in the costs for the development and production of battery-electric vehicles in this problem. Furthermore, this enables or facilitates the development of construction kits and their production, which can be used across different vehicle types, superstructures and equipment features of vehicle platforms.

In the context of the invention, the battery housing is preferably considered an integral part of the unibody of a battery electric vehicle and is basically designed so that all necessary components, in particular of the drive train or the wheel suspension, can be supported or attached to it.

The vehicle concepts in which the vehicle sub-assembly according to the invention can be used differ with regard to the components to be connected. In the luxury class, for example, multi-link suspensions are often used on the front axle, whereas simpler series use typical McPherson suspensions. In the area of light commercial vehicles, transverse leaf springs are sometimes even used to reduce the overall height of the suspension system. All these different suspension components can be supported on the battery housing according to the invention. Thereby these axle concepts require different fastening points and different connections or bearing types. Therefore, the fastening points used on the battery housing can be designed, for example, as screw-on or adaptation points to which the necessary joints can be attached in order to achieve the greatest possible variance. This can be achieved by simple screw-on points on the side surface of the battery housing, by dedicated surfaces to which joints can be welded or in the form of the subframe described.

Thereby it is also possible to combine several connection methods at one fastening point. For example, the corresponding component can be placed on a stud bolt for centering. The stud bolt can also be used for screwing. Alternatively, a screw connection placed next to the stud bolt can be used. Additionally or alternatively, it is possible to positively connect component 4 to the battery housing at the same fastening point, in particular by welding.

### BRIEF DESCRIPTION OF THE DRAWINGS

An embodiment example of the invention is described in detail below with reference to the accompanying drawing. The drawing shows:

FIG. 1 a schematic view of a vehicle sub-assembly according to the invention in an embodiment example,

FIG. 2 a sectional view according to the section A-A marked in FIG. 1,

FIG. 3 a top view of a subframe of the vehicle sub-assembly according to the embodiment example of the invention.

### DETAILED DESCRIPTION

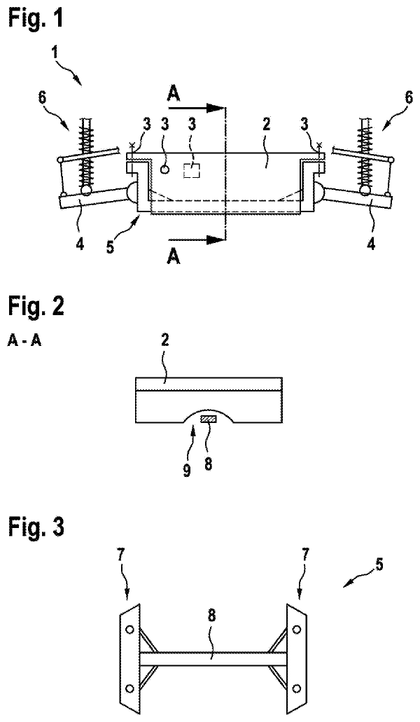

In the following, an embodiment example of a vehicle sub-assembly 1 is described in detail with reference to FIGS. 1 through 3. The vehicle sub-assembly 1 comprises a battery housing 2 for accommodating several storage cells. Furthermore, the vehicle sub-assembly 1 comprises several components 4 supported on the battery housing 2. In the embodiment example shown, a left and right wheel suspension 6 is provided, each having a cross beam. These two cross beams form the components 4 in the embodiment example.

A subframe 5 is fastened to the battery housing 2. The two components 4 are in turn fastened to the subframe 5 so that they can rotate, so that the components 4 are supported on the battery housing 2 by means of the subframe 5.

The battery housing 2 has several fastening points 3, for example fastening points 3 in the form of holes for screwing on the subframe 5.

FIG. 1 purely schematically shows further fastening points 3, for example in the form of a stud bolt or a corresponding surface for welding. Components 4, for example of the wheel suspension or the drive train, can be directly fastened to such fastening points 3.

FIG. 2 shows purely schematically the section A-A marked in FIG. 1. FIG. 3 shows the subframe 5 in a stand-alone position. According to these illustrations, the subframe 5 comprises two opposite side areas 7, to each of which one of the wheel suspensions 6 is attached.

The two side areas 7 are connected to each other via a transverse area 8 of the subframe 5. The transverse area 8 runs in a recess 9. The recess 9 is an indentation extending transversely to the longitudinal direction of the vehicle on the underside of the battery housing 2.

1. A vehicle sub-assembly (1) comprising.
a battery housing (2) with at least one fastening point (3), and
at least one component (4) of a drive train or a wheel suspension (6),
wherein the component (4) is supported on the battery housing (2) via the at least one fastening point (3).

2. The vehicle sub-assembly according to claim 1,
wherein the at least one component (4) of the wheel suspension (6) is a control arm, a swing axle, a stabilizer, a suspension strut, a damper strut, a spring or a damper,
and/or wherein the at least one component (4) of the drive train is an electric motor, a gearbox or a drive shaft bearing.

3. The vehicle sub-assembly according to claim 1, wherein the at least one component (4) is directly fastened to the at least one fastening point (3).

4. The vehicle sub-assembly according to claim 1, further comprising a subframe (5) fastened to the at least one fastening point (3) on the battery housing (2), wherein the at least one component (4) is fastened to the subframe (5).

5. The vehicle sub-assembly according to claim 4, wherein at least one component (4) of a left wheel suspension (6) and at least one component (4) of a right wheel suspension (6) are fastened to the subframe (5).

6. The vehicle sub-assembly according to claim 5,
wherein the subframe (5) comprises a left side area (7) for fastening the left wheel suspension (6) and a right side area (7) for fastening the right wheel suspension (6),
wherein the two side areas (7) are connected by a transverse area (8),
wherein the transverse area (8) extends below the battery housing (2) and/or in front of the battery housing (2) and/or behind the battery housing (2) and/or above the battery housing (2).

7. The vehicle sub-assembly according to claim 4, wherein the battery housing (2) comprises a recess (9) for accommodating the subframe (5).

8. The vehicle sub-assembly according to claim 7 wherein the transverse area (8) is arranged in the recess (9).

9. The vehicle sub-assembly according to claim 4, wherein at least one damping element is arranged between the subframe (5) and the battery housing (2).

10. A vehicle, with a vehicle sub-assembly (1) according to claim 1.

11. The vehicle sub-assembly according to claim 3, wherein the at least one component (4) is screwed or welded to the at least one fastening point (3).

12. The vehicle sub-assembly according to claim 7, wherein the recess (9) is an indentation.

13. The vehicle sub-assembly according to claim 9, wherein the at least one damping element includes an elastomer.

14. The vehicle according to claim 10, wherein the vehicle is a battery electric vehicle.
